(19) United States
(12) Patent Application Publication
(10) Pub. No.: US 2026/0327464 A1
(43) Pub. Date: Oct. 22, 2026

(54) METHOD FOR MANUFACTURING AN ADHESIVE FILM, ADHESIVE FILM, METHOD FOR MANUFACTURING A STRUCTURE, AND STRUCTURE

(71) Applicant: DEXERIALS CORPORATION, Shimotsuke-shi, Tochigi (JP)

(72) Inventors: Makoto MATSUBARA, Tochigi (JP); Kazunobu KAMIYA, Tochigi (JP); Yasushi AKUTSU, Tochigi (JP)

(73) Assignee: DEXERIALS CORPORATION, Shimotsuke-shi, Tochigi (JP)

(21) Appl. No.: 19/491,129

(22) PCT Filed: May 23, 2024
(86) PCT No.: PCT/JP2024/019117

§ 371 Date: Dec. 8, 2025

(30) Foreign Application Priority Data
Jun. 9, 2023 (JP) 2023-095916

(51) Int. Cl. C09J 11/06; C08K 9/10; H01B 5/14

(52) U.S. Cl. CPC C09J 11/06; C08K 9/10; H01B 5/14; C08K 2201/001; C08K 2201/003

(57) ABSTRACT

A method for manufacturing an adhesive film having excellent storage stability, an adhesive film, a method for manufacturing a structure, and a structure, wherein the method includes forming a film layer of a curing-agent-free adhesive composition containing no curing agent, and transferring a latent curing agent from a transfer substrate on which the latent curing agent is disposed to the film layer, and disposing the latent curing agent to be exposed from at least one surface of the film layer or disposed in proximity to at least one surface of the film layer. By disposing the latent curing agent after forming the film layer, progression of the curing reaction can be suppressed and excellent storage stability can be achieved. Furthermore, because the latent curing agent is disposed at the surface of the film layer, a reaction by the curing agent is initiated, enabling excellent adhesive strength to be obtained.

### TECHNICAL FIELD

The present disclosure relates to a method for manufacturing an adhesive film containing a curing agent, an adhesive film produced thereby, a method for manufacturing a structure using the adhesive film, and the resulting structure. This application claims priority based on Japanese Patent Application No. 2023-095916, filed on Jun. 9, 2023, in Japan, and the entire disclosure of that application is incorporated herein by reference.

### BACKGROUND ART

For example, in mounting electronic components, an adhesive film is placed between opposing electronic components and is cured by heating and pressing with a tool. As electronic components become smaller and thinner, thermal damage becomes increasingly undesirable, and therefore lower processing temperatures for such mounting methods are strongly demanded.

In addition, as the curing agent used in adhesive films, latent curing agents—which become reactively active only upon an external stimulus such as heat or light—are employed. For example, Patent Document 1 describes a technique in which a curing agent capable of reacting at low temperatures is encapsulated or otherwise rendered latent so that an adhesive originally requiring mixing of two components can be used as a one-component adhesive.

However, when a latent curing agent is used, the amount and type of solvent during film production are restricted, and the formulation itself is also constrained. In addition, when low-temperature reactivity is required, the heat applied during drying in the film-forming process may prematurely advance the curing reaction, resulting in a reduction in storage stability.

### PRIOR ART DOCUMENTS

### Patent Documents

Patent Document 1: JP 2016-056274 A

### SUMMARY OF THE INVENTION

### Problems to be Solved by the Invention

The present disclosure addresses the aforementioned issues and provides a method for manufacturing an adhesive film having excellent storage stability, the adhesive film itself, a method for manufacturing a structure using the adhesive film, and the resulting structure.

### Means for Solving the Problems

As a result of intensive studies conducted to address the above issues, the inventors have found that the problems can be solved by the following techniques and have thereby completed the present disclosure.

[1]

A method for manufacturing an adhesive film, the method comprising:
a forming step of forming a film layer of a curing-agent-free adhesive composition that contains no curing agent; and
a placing step of transferring a latent curing agent from a transfer substrate on which the latent curing agent is disposed to the film layer, and disposing the latent curing agent so as to be exposed from at least one surface of the film layer or disposed in proximity to at least one surface of the film layer.
   [2]

The method for manufacturing an adhesive film according to item [1], wherein the latent curing agent is disposed in a lump form in the film layer.

[3]

The method for manufacturing an adhesive film according to item [1] or [2], wherein the latent curing agent is of a microcapsule type.

[4]

The method for manufacturing an adhesive film according to item [1] or [2], wherein the curing-agent-free adhesive composition comprises a film-forming resin, a cationically polymerizable compound, and a silane-based compound, and the latent curing agent is an aluminum chelate latent curing agent.

[5]

The method for manufacturing an adhesive film according to item [1] or [2], further comprising a conductive-particle placing step of disposing conductive particles in the film layer.

[6]

The method for manufacturing an adhesive film according to item [1] or [2], wherein in the forming step, conductive particles are blended into the curing-agent-free adhesive composition, and a film layer containing the conductive particles is formed.

[7]

An adhesive film comprising:
a film layer of an adhesive composition in which a latent curing agent is exposed from at least one surface or is disposed in proximity to at least one surface;
wherein the latent curing agent has an average particle diameter of 2 μm to 50 μm, and the film layer has a thickness of 3 μm to 40 μm.
   [8]

A conductive film comprising:
a film layer containing conductive particles, in which a latent curing agent is exposed from at least one surface or is disposed in proximity to at least one surface;
wherein the latent curing agent has an average particle diameter of 2 μm to 50 μm, and the film layer has a thickness of 3 μm to 40 μm.
   [9]

An anisotropic conductive film comprising:
a film layer containing conductive particles, in which a latent curing agent is exposed from at least one surface or disposed in proximity to at least one surface;
wherein the latent curing agent has an average particle diameter of 2 μm to 50 μm, and the film layer has a thickness of 3 μm to 40 μm.
   [10]

A method for manufacturing a structure, the method comprising bonding a first component and a second component via the adhesive film according to item [7].

[11]

A method for manufacturing a connection structure, the method comprising connecting a terminal of a first component and a terminal of a second component via the adhesive film according to item [7], the conductive film according to item [8], or the anisotropic conductive film according to item [9].

[12]

A structure in which a first component and a second component are bonded via the adhesive film according to item [7].

[13]

A connection structure in which a terminal of a first electronic component and a terminal of a second electronic component are connected via the adhesive film according to item [7], the conductive film according to item [8], or the anisotropic conductive film according to item [9].

According to the present disclosure, by disposing the latent curing agent after forming the film, progression of the curing reaction caused by the solvent with respect to the latent curing agent can be suppressed, and excellent storage stability can be obtained. In addition, by disposing the latent curing agent on the surface of the film layer, the reaction by the curing agent is initiated, and excellent adhesive strength can be obtained.

### BRIEF DESCRIPTION OF THE DRAWINGS

FIG. 1 is a flowchart illustrating processes from the manufacture to the use of an adhesive film according to the present embodiment.

FIG. 2 is a cross-sectional view schematically illustrating a state in which a transfer substrate filled with a latent curing agent and a film layer are opposed to each other.

FIG. 3 is a cross-sectional view schematically illustrating a state in which the latent curing agent is adhered to a surface of the film layer.

FIG. 4 is a cross-sectional view schematically illustrating a state in which the latent curing agent is pressed into the film layer.

FIG. 5 is a cross-sectional view schematically illustrating an adhesive film of a first embodiment.

FIG. 6 is a cross-sectional view schematically illustrating a modified example of an adhesive film of the first embodiment.

FIG. 7 is a cross-sectional view schematically illustrating an adhesive film of a second embodiment.

FIG. 8 is a cross-sectional view schematically illustrating an adhesive film of a third embodiment.

### MODES FOR CARRYING OUT THE INVENTION

Hereinafter, embodiments of the present disclosure will be described in detail with reference to the drawings in the following order.
1. Method for manufacturing an adhesive film
2. Adhesive film
3. Method for manufacturing a structure and structure
4. Examples

### 1. Method for Manufacturing an Adhesive Film

The method for manufacturing an adhesive film according to the present embodiment includes a forming step of forming a film layer of a curing-agent-free adhesive composition that contains no curing agent, and a placing step of transferring a latent curing agent from a transfer substrate on which the latent curing agent is disposed to the film layer, and disposing the latent curing agent so as to be exposed from at least one surface of the film layer or disposed in proximity to at least one surface of the film layer. By this, progression of the curing reaction caused by the solvent with respect to the latent curing agent can be suppressed, and excellent storage stability can be obtained.

Here, the curing-agent-free adhesive composition refers to one that does not contain a curing agent and does not function as an adhesive, for example, upon an external stimulus such as heat or light. In addition, the latent curing agent refers to one that becomes reactively active only upon an external stimulus such as heat or light and is in the form of powder solid particles. It is preferable that the powder solid particles can be observed under a microscope at 5 to 35° C. Examples of the latent curing agent include a microcapsule type in which a curing-agent component is used as a core material and is coated with a coating agent (shell) such as an organic polymer or an inorganic compound, and an impregnation type in which a curing-agent component is contained in porous particles.

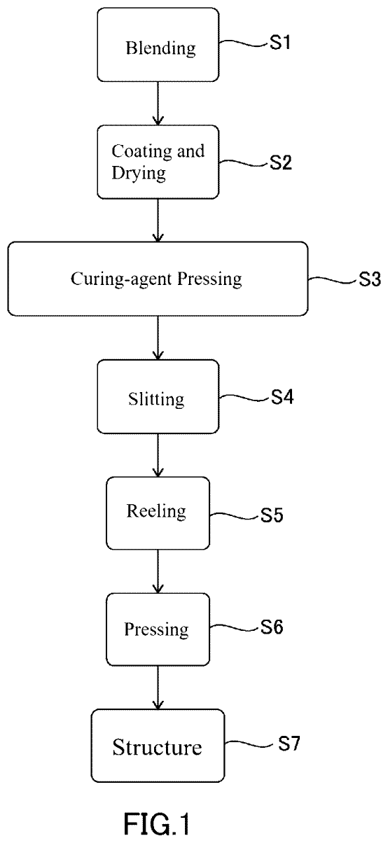

FIG. 1 is a flowchart illustrating processes from the manufacture to the use of an adhesive film according to the present embodiment. As shown in FIG. 1, the processes from the manufacture to the use of the adhesive film include: a blending step S1 of blending a curing-agent-free adhesive composition; a coating and drying step S2 of coating and drying the curing-agent-free adhesive composition to obtain a film; a curing-agent pressing-in step S3 of pressing a curing agent into a surface of the film; a slitting step S4 of obtaining a film having a predetermined width; a reeling step S5 of winding the film of the predetermined width; a pressing step S6 of drawing out the film from the reel and pressing a first electronic component and a second electronic component with the film interposed therebetween; and a structure forming step S7 of obtaining a structure including the first electronic component and the second electronic component. In addition, when an anisotropic conductive film is produced as an example of the adhesive film by disposing conductive particles, it is preferable that a conductive-particle placing step be provided before or after the curing-agent pressing-in step S3. Further, in the blending step S1, conductive particles may be mixed in advance, and in such a case, the conductive particles are three-dimensionally and randomly dispersed in the adhesive film.

In the conventional method, because production of the adhesive film is started by calculating backward from the pressing step in anticipation of the reaction of the curing agent from the time of blending in which the curing agent is added, the manufacturing line must be continuously operated until shipment is completed, in which the film is wound into a wound product by winding the film around a reel, and there are restrictions on manufacturing management. In addition, even after shipment, the wound product is stored and managed under constraints of manufacturing management of the structure until completion of the use of the adhesive film (completion of the connection step).

On the other hand, in the present embodiment, because a curing agent is not added in the blending step S1, restrictions on the amount and type of solvent can be reduced. In addition, in the coating and drying step S2, progression of the curing reaction caused by the heat of drying during film formation can be prevented. Furthermore, because the curing-agent pressing-in step S3 becomes the start of the reaction of the curing agent, and because the manufacturing process (mass-production line) can be temporarily stopped before the curing-agent pressing-in step S3, when calculated backward from the pressing step S6, the life of the product can be easily controlled. In addition, because flexibility in manufacturing schedules and time management is increased, industrial advantages occur, such as a significant reduction in restrictions on manufacturing management compared with the conventional method. The present embodiment may employ a wound product in which the adhesive film is wound around a reel, and the length of the adhesive film is preferably, for example, 5 m or more because connection using an apparatus can be performed, and preferably 5000 m or less because it is preferable for attachment to the apparatus. The width of the adhesive film is preferably, for example, 0.5 mm or more and 60 cm or less. The adhesive film may also be in a sheet form, and although the size is not particularly limited, one side of the sheet is preferably 5 cm or more, and more preferably 20 cm or more for use. The maximum of one side in the sheet form is preferably, for example, 200 cm or less for handling.

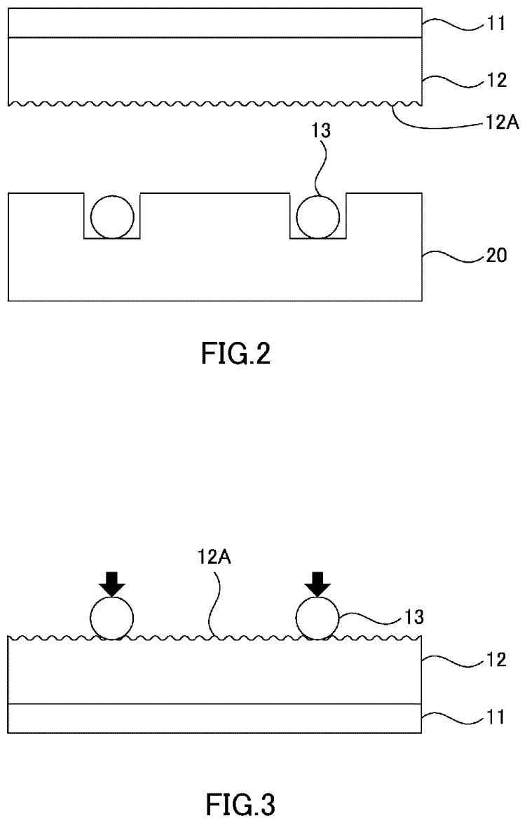

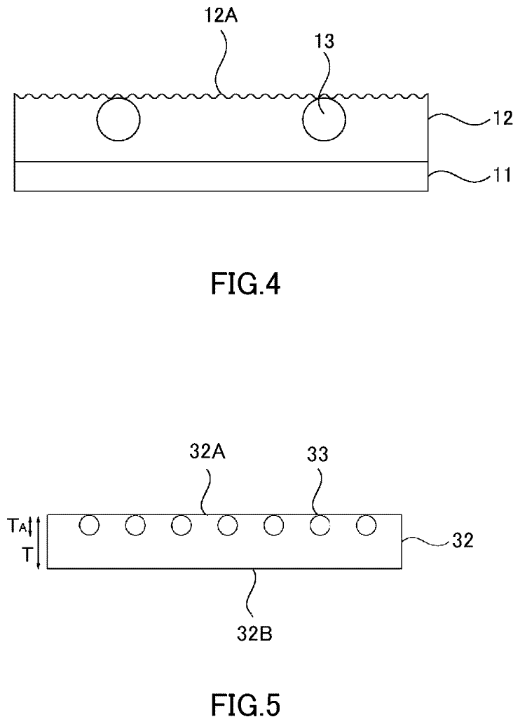

Hereinafter, with reference to FIGS. 2 to 4, the forming step (A) of forming the film layer and the placing step (B) of disposing the latent curing agent will be described. FIG. 2 is a cross-sectional view schematically illustrating a state in which a transfer substrate filled with a latent curing agent and the film layer are opposed to each other; FIG. 3 is a cross-sectional view schematically illustrating a state in which the latent curing agent is adhered to the surface of the film layer; and FIG. 4 is a cross-sectional view schematically illustrating a state in which the latent curing agent is pressed into the film layer.

### [Forming Step (A)]

In the forming step (A), first, a curing-agent-free adhesive composition that does not contain a curing agent is prepared. The adhesive composition may use a well-known insulating binder. Examples of the curing type include a thermosetting type, a photo-curing type, and a combined photo/thermal curing type. Examples include a thermal cationic polymerization resin composition containing an epoxy compound and a thermal cationic polymerization initiator, a thermal anionic polymerization resin composition containing an epoxy compound and a thermal anionic polymerization initiator, a photo-radical polymerization resin composition containing a (meth)acrylate compound and a photo-radical polymerization initiator, and a thermal radical polymerization resin composition containing a (meth)acrylate compound and a thermal radical polymerization initiator. That is, in the case of a thermal cationic polymerization resin composition, for example, the curing-agent-free adhesive composition contains a cationically polymerizable compound such as an epoxy compound without containing a thermal cationic polymerization initiator.

In addition, a solvent may be used in preparing the curing-agent-free adhesive composition. Examples of the solvent include, for example, propylene glycol monomethyl ether acetate (PMA) and methyl ethyl ketone (MEK).

Next, the curing-agent-free adhesive composition is applied onto a base film 11 and dried to evaporate the solvent, thereby forming, on the base film 11, a film layer 12 of the curing-agent-free adhesive composition having a predetermined thickness. The residual amount of the solvent in the film layer 12 is preferably less than 1%, more preferably less than 0.5%, and even more preferably less than 0.1%. By this, progression of the curing reaction caused by the solvent with respect to the latent curing agent can be suppressed, and excellent storage stability can be obtained. As the base film 11, for example, a PET film subjected to a release treatment with a silicone resin can be suitably used.

### [Placing Step (B)]

In the placing step (B), first, the latent curing agent 13 is made to be held on a first surface 12A of the film layer 12. Examples of methods for holding the latent curing agent 13 include a transfer method in which the latent curing agent 13 is transferred to the film layer 12 using a transfer substrate 20, and a scattering method in which the latent curing agent 13 is scattered onto the film layer 12. Among these, the transfer method can uniformly dispose the latent curing agent in a plan view, and by pressing with a flat plate or the like after transfer, the position in the thickness direction can also be uniformly disposed, so that excellent adhesive strength (die shear strength, peel strength) can be obtained.

As shown in FIG. 2, in the transfer method, the transfer substrate 20 filled with the latent curing agent 13 and the film layer 12 are opposed to each other, and the film layer 12 is pressed against the transfer substrate 20, thereby holding the latent curing agent 13 on the first surface 12A of the film layer 12.

The transfer substrate 20 has recesses formed at a predetermined number density in a predetermined arrangement. Such a transfer substrate 20 can be produced, for example, by preparing a mold having projections of a predetermined number density in a predetermined arrangement, pouring resin pellets into the mold in a molten state, and cooling and solidifying the resin. The transfer substrate 20 may also be one in which openings are formed, for example, in inorganic materials such as silicon, ceramics, glass, or metals such as stainless steel, or in organic materials such as various resins, by a well-known opening-forming method such as photolithography. The transfer substrate 20 may be in a plate form or in a roll form.

Next, as shown in FIGS. 3 and 4, the latent curing agent 13 adhered to the first surface 12A of the film layer 12 is pressed into the film layer 12. By this, the latent curing agent 13 can be exposed from the first surface 12A of the film layer 12 or disposed in proximity to the first surface 12A of the film layer 12, and can be disposed in a dispersed manner in a plan view. In addition, the embedding amount of the latent curing agent 13 into the film layer 12 can be adjusted by the pressing force, temperature, and the like at the time of pressing in the latent curing agent 13.

In addition, a plurality of latent curing agents 13 may be filled in one recess of the transfer substrate 20, and the latent curing agents 13 may be disposed in a lump form in the film layer 12. This makes it possible to arrange the latent curing agents 13 in the film layer 12 even when there is a large variation in the particle diameter of the latent curing agents 13.

In addition, the number density of the latent curing agents 13 arranged in the film layer 12 is preferably the same as the number density of the recesses of the transfer substrate 20, and may be equal to or less than the number density of the recesses of the transfer substrate 20 when the transfer rate of the latent curing agents 13 is low. When the latent curing agents 13 are arranged in the film layer 12 in a lump form, the number density of the latent curing agents 13 may be counted by treating each lump as one unit; that is, the number density may be the number density of the lumps of the latent curing agents 13. The number density of the latent curing agents 13 can be measured by microscopic observation. The number density of the latent curing agents 13 can also be determined based on, for example, the content of the latent curing agents 13 in the adhesive composition containing the latent curing agents 13, the area of the film layer 12, and the transfer rate of the latent curing agents 13.

In addition, when the latent curing agent 13 is disposed on the second surface of the film layer 12, the latent curing agent 13 is held on the second surface of the film layer 12 and the latent curing agent 13 is pressed into the film layer 12 in the same manner as described above. By this, the latent curing agent 13 can be disposed on both surfaces of the film layer 12.

In addition, the method for producing the adhesive film may further include a conductive-particle placing step in which conductive particles are disposed in the film layer 12. In the conductive-particle placing step, similarly to the placing step (B) in which the latent curing agent 13 is disposed, the conductive particles are held by a transfer method in which the conductive particles are transferred to the film layer 12 using a transfer substrate, or by a scattering method in which the conductive particles are scattered onto the film layer 12, and the conductive particles are pressed into the film layer 12, thereby disposing the conductive particles in the film layer 12. In addition, in the forming step (A), conductive particles may be blended into the curing-agent-free adhesive composition to disperse the conductive particles in the film layer 12. By this, a conductive film or an anisotropic conductive film containing conductive particles can be produced.

The state of placement and embedding of the latent curing agent or the conductive particles into the film layer and the shape of the resin may be in accordance with Japanese Patent No. 6187665.

In addition, the adhesive film, the conductive film, or the anisotropic conductive film in which the latent curing agent 13 is disposed may be one in which the film layer 12 is laminated. By this, for example, adhesive strength (die shear strength, peel strength) can be improved, and particle-capturing performance of the conductive particles can be improved.

According to such a method for producing the adhesive film, by disposing the latent curing agent on the coated film, a curing agent that was difficult to use from the viewpoint of the temperature applied during film formation and solvent resistance can be made usable. In addition, for example, when the latent curing agent is an aluminum-chelate-type latent curing agent and conductive particles are disposed, an anisotropic conductive film that can be cured at a low temperature while maintaining the latency without impairing the latency of the curing agent and that allows good adhesion can be produced. Furthermore, when this anisotropic conductive film, in which the latent curing agent and the conductive particles are disposed, is used for anisotropic conductive connection between electronic components, curing at a low temperature and good adhesion can be achieved, and a connection having a stable particle arrangement can be obtained.

In addition, the present production method does not blend the latent curing agent into a liquid adhesive composition but, after forming the adhesive composition into a film, disposes and allows the latent curing agent to be present in the vicinity of the surface of the film layer. The difference between the adhesive film according to the present production method and an adhesive film formed by coating a resin composition (liquid, paste, slurry, and the like) in which a latent curing agent is blended can be distinguished by whether or not the latent curing agent is disposed. The ability to provide the latent curing agent at a predetermined position increases convenience as an adhesive film and enables the performance to be controlled more precisely, and results in not being subject to compositional restrictions of the adhesive composition. An example relating to convenience is being able to accommodate the production schedule of the adhesive film as described earlier, and an example of being able to control performance more precisely is that it becomes possible to provide the latent curing agent only at predetermined planar positions of the adhesive film and, by giving a planar non-uniformity to the latent curing agent, to vary the curing reaction within the plane of the adhesive film (for example, enabling creation of places where curing proceeds more quickly and places where it does not), and the like.

### 2. Adhesive Film

The adhesive film according to the present embodiment has a film layer of an adhesive composition in which the latent curing agent is exposed from at least one surface or is disposed in proximity to at least one surface. By the latent curing agent being disposed on the surface of the film layer, the curing reaction is initiated, and excellent adhesive strength (die shear strength, peel strength) can be obtained.

As described above, the adhesive composition may use a well-known insulating binder. Examples of the curing type include a thermosetting type, a photo-curing type, and a combined photo/thermal curing type. Examples include a thermal cationic polymerization resin composition containing an epoxy compound and a thermal cationic polymerization initiator, a thermal anionic polymerization resin composition containing an epoxy compound and a thermal anionic polymerization initiator, a photo-radical polymerization resin composition containing a (meth)acrylate compound and a photo-radical polymerization initiator, and a thermal radical polymerization resin composition containing a (meth)acrylate compound and a thermal radical polymerization initiator.

Examples of the latent curing agent include, for example, aluminum-chelate-type curing agents, imidazole-type curing agents, hydrazide-type curing agents, boron trifluoride-amine complexes, sulfonium salts, amine imides, salts of polyamines, and dicyandiamide. These latent curing agents may be used singly or in combination of two or more kinds, and a decomposition accelerator, an inhibitor, and the like may be mixed and used. Among these, by using the above-described method for producing the adhesive film, an aluminum-chelate-type latent curing agent, which has been difficult to use from the viewpoint of solvent resistance, can be used. The aluminum-chelate-type latent curing agent, by being added to a cationically polymerizable compound and a silane compound, can provide a thermal cationic polymerization resin composition having low-temperature rapid-curing properties.

Hereinafter, as an example of the adhesive composition that forms the film layer, a thermal cationic polymerization resin composition containing a film-forming resin, a cationically polymerizable compound, an aluminum-chelate-type latent curing agent, and a silane compound will be described.

### (Film-Forming Resin)

The film-forming resin corresponds, for example, to a high-molecular-weight resin having an average molecular weight of 10,000 or more, and from the viewpoint of film formability, the average molecular weight is preferably about 10,000 to 80,000. Examples of the film-forming resin include various resins such as phenoxy resins, epoxy resins, polyester resins, polyurethane resins, polyester-urethane resins, acrylic resins, polyimide resins, and butyral resins, and these may be used singly or in combination of two or more kinds. Among these, from the viewpoint of film-forming condition and connection reliability, it is preferable to suitably use a phenoxy resin. The content of the film-forming resin is preferably 20 to 80 wt %, and more preferably 30 to 60 wt %.

### (Cationically Polymerizable Compound)

As the cationically polymerizable compound, at least one selected from epoxy compounds and oxetane compounds can be used.

As the epoxy compound, it is preferable to use one having five or fewer functional groups. Examples of the epoxy compound having five or fewer functional groups include, for example, glycidyl ether-type epoxy compounds, glycidyl ester-type epoxy compounds, alicyclic epoxy compounds, bisphenol A-type epoxy compounds, bisphenol F-type epoxy compounds, dicyclopentadiene-type epoxy compounds, novolac phenol-type epoxy compounds, biphenyl-type epoxy compounds, and naphthalene-type epoxy compounds, and one may be used singly or two or more may be used in combination from among these. As a specific example of an alicyclic epoxy resin commercially available on the market, there can be mentioned “CELLOXIDE 8000” manufactured by Daicel Corporation.

Examples of the oxetane compound include, for example, biphenyl-type oxetane compounds, xylylene-type oxetane compounds, silsesquioxane-type oxetane compounds, ether-type oxetane compounds, phenol novolac-type oxetane compounds, and silicate-type oxetane compounds, and one may be used singly or two or more may be used in combination from among these. As a specific example of a commercially available biphenyl-type oxetane compound, there can be mentioned “OXBP” manufactured by UBE Corporation.

The content of the cationically polymerizable compound is preferably 10 to 70 wt %, and more preferably 20 to 50 wt %. When the content of the cationically polymerizable compound is too high, there is a tendency for curing shrinkage to increase.

### (Aluminum-Chelate-Type Latent Curing Agent)

Examples of the aluminum-chelate-type latent curing agent include, for example, those in which an aluminum-chelate-type curing agent is held in a porous resin obtained by interfacially polymerizing a polyfunctional isocyanate compound and, at the same time, radically polymerizing a radical-polymerizable compound in the presence of a radical polymerization initiator.

Specific examples of the aluminum-chelate-type curing agent include aluminum tris(acetylacetonate), aluminum tris(ethyl acetoacetate), aluminum monoacetylacetonate bis(ethyl acetoacetate), aluminum monoacetylacetonate bis(oleyl acetoacetate), ethyl acetoacetate aluminum diisopropylate, and alkyl acetoacetate aluminum diisopropylate.

Since the aluminum-chelate-type latent curing agent is mainly produced by using an interfacial polymerization method, the shape of the porous resin is spherical, and the pore size is preferably 5 to 150 nm from the viewpoint of curability and latency. In addition, the average particle diameter of the aluminum-chelate-type latent curing agent is preferably 0.5 to 100 μm from the viewpoint of curability and dispersibility.

In addition, as in Japanese Patent No. 6489494, it is preferable that the aluminum-chelate-type curing agent be held in a large number of fine pores present in a porous resin matrix, and that the surface thereof be subjected to an inactivation treatment with an alkoxysilane coupling agent.

The alkoxysilane coupling agents used for the surface inactivation treatment are classified into two types as described below.

The first type is a silane coupling agent that reacts with the active aluminum-chelate-type curing agent on the surface of the aluminum-chelate-type latent curing agent to produce an aluminum-chelate-silanol reaction product, and thereby reduces the electron density of the oxygen adjacent to the aluminum atom (in other words, reduces the acidity of the hydrogen bonded to the oxygen, and further in other words, reduces the polarizability between the oxygen and the hydrogen), thereby lowering the activity. Examples of this type of silane coupling agent include alkoxysilane coupling agents in which an electron-donating group is bonded to the silicon atom, preferably alkylalkoxysilane coupling agents having an alkyl group. Specific examples include methyltrimethoxysilane, n-propyltrimethoxysilane, and hexyltrimethoxysilane.

The second type is a silane coupling agent that lowers the activity by coating the surface with an epoxy polymer chain produced by reacting an epoxy group in the molecule with the active aluminum-chelate-type curing agent on the surface of the aluminum-chelate-type latent curing agent. Examples of this type of silane coupling agent include epoxy silane coupling agents. Specific examples include 2-(3,4-epoxycyclohexyl)ethyltrimethoxysilane (KBM-303, Shin-Etsu Chemical Co., Ltd.) and 3-glycidoxypropyltrimethoxysilane (KBM-403, Shin-Etsu Chemical Co., Ltd.).

As the method for the surface inactivation treatment of the aluminum-chelate-type latent curing agent with an alkoxysilane coupling agent, there can be mentioned a method in which the agent is immersed for 1 to 20 hours at 25 to 80° C. in a solution in which the alkoxysilane coupling agent is dissolved preferably at 5 to 80% by mass in an organic solvent, preferably a nonpolar solvent, particularly cyclohexane. The solution may also be stirred during the immersion.

The content of the aluminum-chelate-type latent curing agent is preferably 1 to 50 wt %, and more preferably 3 to 20 wt %. When the content of the aluminum-chelate-type latent curing agent is too low, curing is insufficient, and when the content is too high, the resin properties (for example, flexibility) of the cured product of the composition tend to decrease.

### (Silane Compound)

The silane compound can cooperate with the aluminum-chelate-type curing agent to initiate cationic polymerization and promote curing. Examples of the silane compound include highly sterically hindered silanol compounds, and silane coupling agents having 1 to 3 lower alkoxy groups in the molecule.

Specific examples of the silanol compounds include tris(tert-pentoxy) silanol, tris(tert-butoxy) silanol, and bis(tert-butoxy) (isopropoxy) silanol. In addition, specific examples of the silane coupling agents include vinyltris(β-methoxyethoxy) silane, vinyltriethoxysilane, vinyltrimethoxysilane, γ-styryltrimethoxysilane, and γ-methacryloxypropyltrimethoxysilane.

The content of the silanol compound is preferably 1 to 50 wt %, and more preferably 3 to 20 wt %. When the content of the silanol compound is too low, curing becomes insufficient, and when the content is too high, the resin properties after curing tend to decrease.

### (Other Additives)

In addition, it is preferable that the thermal cationic polymerization resin composition contain an inorganic filler. Examples of the inorganic filler include silica, talc, titanium oxide, calcium carbonate, and magnesium oxide. The inorganic filler may be used singly or in combination of two or more kinds. The content of the inorganic filler is preferably 1 to 50 wt %, and more preferably 3 to 20 wt %. In addition, the thermal cationic polymerization resin composition may contain, as needed, pigments, antistatic agents, and the like.

According to such a thermal cationic polymerization resin composition, because an aluminum-chelate-type latent curing agent is used, excellent storage stability can be obtained despite the composition being a one-component type. In addition, by containing a highly sterically hindered silanol compound, cationic polymerization can be carried out with low-temperature rapid curing.

In addition, the adhesive film may be used as a conductive film or an anisotropic conductive film by using conductive particles. In this case, the conductive particles may be mixed into the resin composition and three-dimensionally dispersed, or may be disposed after film formation. When the conductive particles are disposed after film formation, similarly to the latent curing agent, they may be disposed flush with the film surface and two-dimensionally, and may have regularity. Examples of the conductive particles include, but are not limited to, particles of metals and metal alloys including nickel, iron, copper, aluminum, tin, lead, chromium, cobalt, silver, and gold; particles having a metal coating on the surface of particles such as metal oxides, carbon, graphite, glass, ceramics, and plastics; and particles in which the surfaces of these particles are further provided with an insulating thin film or to which insulating fine particles are adhered, i.e., insulating-treated particles. Two or more kinds among these may be mixed. When the particles are those having a metal coating on the surfaces of resin particles, examples of the resin particles include epoxy resin particles, phenolic resin particles, acrylic resin particles, acrylonitrile-styrene (AS) resin particles, benzoguanamine resin particles, divinylbenzene-based resin particles, and styrene-based resin particles.

The average particle diameter of the conductive particles is not particularly limited, but the lower limit of the average particle diameter is preferably 1 μm or more, and the upper limit of the average particle diameter is preferably, for example, 50 μm or less from the viewpoint of the capture efficiency of the conductive particles in the connection structure, and more preferably 20 μm or less. The average particle diameter may be the particle diameter at a cumulative value of 50%, measured by an image-type particle-size distribution analyzer (for example, FPIA-3000 manufactured by Malvern).

### First Embodiment

FIG. 5 is a cross-sectional view schematically illustrating an adhesive film of the first embodiment. As shown in FIG. 5, the adhesive film of the first embodiment has a film layer 32 of an adhesive composition in which the latent curing agent 33 is exposed from the first surface 32A or is disposed in proximity to at least the first surface 32A.

The lower limit of the thickness T of the film layer 32 may be, for example, the same as the average particle diameter of the latent curing agent 33, and may preferably be 1.3 times or more the average particle diameter or 3 μm or more. In addition, the upper limit of the thickness T of the film layer 32 may be, for example, 40 μm or less or 12 times or less the average particle diameter. The film thickness can be measured using a known micrometer or digital thickness gauge. The film thickness may be obtained by measuring, for example, 10 or more locations and determining the average value.

The lower limit of the average particle diameter of the latent curing agent 33 is preferably 2 μm or more, and the upper limit of the particle diameter is preferably, for example, 50 μm or less, and more preferably 20 μm or less. The average particle diameter can be defined as the particle diameter at a cumulative value of 50% as measured by an image-type particle size distribution analyzer (for example, FPIA-3000 manufactured by Malvern).

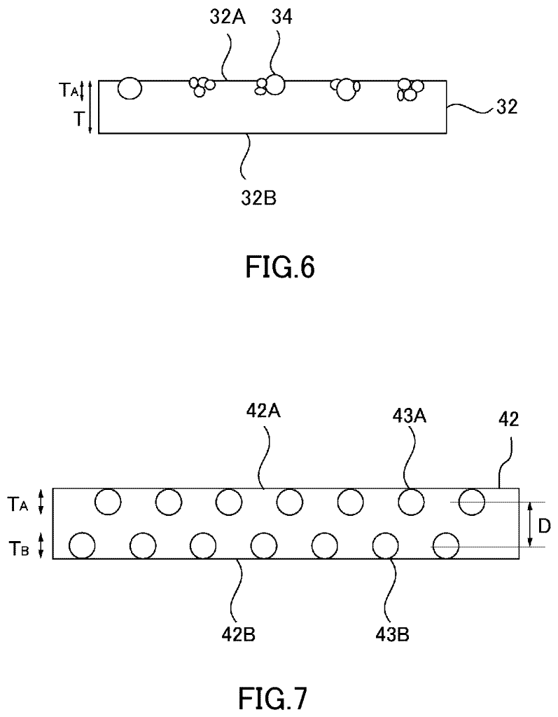

FIG. 6 is a schematic cross-sectional view illustrating a modified example of the adhesive film of the first embodiment. As shown in FIG. 6, the adhesive film may have the latent curing agent 34 arranged in the film layer 32 in a lump form. When in a lump form, it is preferable that the size of the lump satisfy the aforementioned upper and lower limits. The average particle diameter of the lump-form latent curing agent 33 can be determined from observation with an electron microscope such as an SEM. In this case, it is preferable that the number of samples for which the particle diameter is measured be 200 or more.

The lower limit of the embedding depth TA of the latent curing agent 33 in the film layer 32 is preferably 0.8 times or more, and more preferably 1.0 times or more, of the average particle diameter of the latent curing agent 33, and the upper limit of the embedding depth TA is preferably 1.5 times or less, and more preferably 1.2 times or less, of the average particle diameter of the latent curing agent 33. That is, the latent curing agent 33 may be exposed at the surface of the film layer 32, or may be completely embedded. The embedding depth of the latent curing agent in the film layer can be determined from observation with an electron microscope such as an SEM.

The latent curing agent 33 may be arranged randomly in plan view of the first surface 32A, or may be arranged with regularity. Among these, it is preferable that the arrangement of the latent curing agent 33 be a regular array such as a lattice pattern or a staggered pattern. Examples of lattice patterns include oblique lattices, hexagonal lattices, square lattices, rectangular lattices, and parallelogram lattices. In this manner, the particle surface density of the latent curing agent 33 arranged on the surface becomes uniform, and the adhesive strength (die shear strength, peel strength) can be further improved. The latent curing agent may be arranged individually, or may be arranged in a lump form in which particles are aggregated. Even in the case of aggregation, it is preferable that the aggregated lumps be arranged with regularity as described above.

### Second Embodiment

FIG. 7 is a cross-sectional view schematically illustrating an adhesive film according to a second embodiment. As shown in FIG. 7, the adhesive film of the second embodiment has a film layer 42 of an adhesive composition in which a latent curing agent 43A is arranged so as to be exposed from the first surface 42A or so as to be positioned in proximity to the first surface 42A, and a latent curing agent 43B is arranged so as to be exposed from the second surface 42B or so as to be positioned in proximity to the second surface 42B.

The lower limit of the thickness of the film layer 42 may, for example, be the same as the average particle diameters of the latent curing agents 43A and 43B, and is preferably 1.3 times or more the average particle diameter, or 3 μm or more. When the thickness of the film layer 42 is less than twice the sum of the average particle diameter of the latent curing agent 43A and the average particle diameter of the latent curing agent 43B, it is desirable that the latent curing agent 43A on the first surface 42A and the latent curing agent 43B on the second surface 42B be arranged so as not to overlap in plan view. The thickness of the film layer 42 may, for example, be the same as the sum of the average particle diameter of the latent curing agent 43A and the average particle diameter of the latent curing agent 43B, and is preferably 1.3 times or more the sum of the average particle diameters. The upper limit of the thickness of the film layer 42 may, for example, be 40 μm or less, or, for example, 12 times or less the sum of the average particle diameters of the latent curing agents 43A and 43B. The embedding depth TA of the latent curing agent 43A in the film layer 42 and the embedding depth TB of the latent curing agent 43B are the same as in the first embodiment, and thus description thereof is omitted.

When the latent curing agents 43A and 43B are arranged on both surfaces of the film layer 42, or when the film layer 42 is laminated, or when the film layer 32 having the latent curing agent 33 arranged on one surface is laminated, the distance D between adjacent latent curing agents in the film-thickness direction is preferably 5 times or less the average particle diameter of the latent curing agent, more preferably 3 times or less, and still more preferably 2 times or less. In this manner, since the positional deviation of the latent curing agents in the film-thickness direction becomes small, excellent adhesiveness can be obtained. The distance in the film-thickness direction between adjacent latent curing agents in the film layer can be obtained as the distance between the average position of the center of the latent curing agent arranged on one side and the average position of the center of the latent curing agent arranged on the other side, based on observation using an electron microscope such as an SEM.

As in the first embodiment, the latent curing agents 43A and 43B may be arranged randomly in plan view of the first surface 42A or the second surface 42B, or may be arranged with regularity. Among these, it is preferable that the arrangement of the latent curing agents 43A and 43B be a regular array such as a lattice pattern or a staggered pattern. In this manner, the particle surface densities of the latent curing agents 43A and 43B arranged on both surfaces become uniform, and the adhesive strength (die shear strength, peel strength) can be further improved.

### Third Embodiment

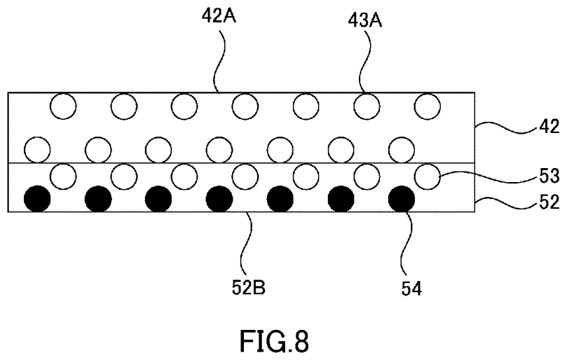

FIG. 8 is a cross-sectional view schematically illustrating an adhesive film according to a third embodiment. As shown in FIG. 8, the adhesive film of the third embodiment has a film layer 52 of an adhesive composition in which a latent curing agent 53A is arranged so as to be exposed from the first surface 52A or so as to be positioned in proximity to the first surface 52A, and conductive particles 54 are arranged so as to be exposed from the second surface 52B or so as to be positioned in proximity to the second surface 52B. The adhesive film of the third embodiment further has a film layer 42 of an adhesive composition in which a latent curing agent 43A is arranged so as to be exposed from the first surface 42A or so as to be positioned in proximity to the first surface 42A, and a latent curing agent 43B is arranged so as to be exposed from the second surface 42B or so as to be positioned in proximity to the second surface 42B. That is, the adhesive film of the third embodiment is obtained by laminating the film layer 42 onto the first surface 52A of the film layer 52. The film layer 42 is the same as in the second embodiment, and therefore description thereof is omitted.

The lower limit of the thickness of the film layer 52 may, for example, be the same as the average particle diameters of the latent curing agent 53 and the conductive particles 54, and is preferably 1.3 times or more the average particle diameter, or 3 μm or more. When the thickness of the film layer 52 is less than twice the sum of the average particle diameter of the latent curing agent 53 and the average particle diameter of the conductive particles 54, it is desirable that, in plan view, the latent curing agent 53 on the first surface 52A and the conductive particles 54 on the second surface 52B be arranged so as not to overlap with each other.

It is preferable that the latent curing agent 53 arranged on the first surface 52A have regularity, as in the first embodiment, and it is preferable that the arrangement be a regular array such as a lattice pattern or a staggered pattern. In this manner, the particle surface density of the latent curing agent 53 arranged on the surface becomes uniform, and the adhesive strength (die shear strength, peel strength) can be further improved.

The conductive particles 53 need only be dispersed in the film layer 52, but are preferably contained in a regularly arranged manner, and in plan view, it is preferable that the arrangement be a regular array such as a lattice pattern or a staggered pattern. Examples of the lattice pattern include an oblique lattice, a hexagonal lattice, a square lattice, a rectangular lattice, and a parallelogram lattice. In this manner, the particle surface density of the conductive particles 53 arranged on the surface becomes uniform, and the connection reliability can be improved.

### 3. Method for Manufacturing a Structure and Structure

The method for manufacturing a structure according to the present embodiment is one in which a first part and a second part are bonded to each other through the above-described adhesive film, and the structure according to the present embodiment is one in which the first part and the second part are bonded to each other through the above-described adhesive film. The adhesive film may also be a conductive film or an anisotropic conductive film, and the method for manufacturing a connection structure may be one in which terminals of a first electronic part and terminals of a second electronic part are connected to each other through the conductive film or the anisotropic conductive film, and the connection structure may be one in which the terminals of the first electronic part and the terminals of the second electronic part are connected to each other through the conductive film or the anisotropic conductive film.

The first electronic part and the second electronic part are not particularly limited and may be appropriately selected depending on the purpose. Examples of the first electronic part include, for example, plastic substrates, glass substrates, and printed wiring boards (PWB) for LCD (Liquid Crystal Display) panel applications and organic EL display (OLED) panel applications. Examples of the second electronic part include, for example, flexible substrates (FPC: Flexible Printed Circuits) such as IC (Integrated Circuit) and COF (Chip On Film), and tape carrier package (TCP) substrates.

At the time of connection, heat-pressing is performed from above the second electronic part by a bonding tool heated to a predetermined temperature, under a predetermined pressure and for a predetermined time, and the terminal of the first electronic part and the terminal of the second electronic part are connected to each other. In addition, when the adhesive film is a conductive film or an anisotropic conductive film, the conductive particles are sandwiched between the terminal of the first electronic part and the terminal of the second electronic part and are crushed, and in this state, the binder is cured.

The predetermined pressure at the time of heat-pressing is preferably 1 MPa or more and 150 MPa or less from the viewpoint of preventing wiring cracks in the electronic parts. The predetermined temperature is preferably 80° C. or more and 230° C. or less. In addition, when a photoreaction initiator is blended, for example, ultraviolet (UV) irradiation may be used in combination.

A cushioning material may also be interposed between the bonding tool and the second electronic part to perform heat-pressing. By interposing the cushioning material, the variation in pressing can be reduced, and contamination of the bonding tool can be prevented. The cushioning material is made of an elastic material or a plastic material in sheet form, and examples include polytetrafluoroethylene (Teflon™), silicone rubber, and the like.

According to such a method for manufacturing a structure, since an adhesive film in which the latent curing agent is arranged on the surface of the film layer is used, the curing-agent reaction is initiated simultaneously, and excellent adhesive strength (die shear strength, peel strength) can be obtained.

In addition, the present technology is not limited to the above-described embodiments, and can be applied also to materials in which, in a method for performing coating and drying in the course of film manufacture using materials and a solvent and performing mixing, dissolution, and dispersion, undesirable chemical changes or physical changes occur by the nature of using a solvent in its presence. For example, a material having solubility or aggregability can also be arranged on the film surface.

Furthermore, the present technology is not limited to applications that use a solvent, and can also be applied to materials that undergo changes with respect to mixing or stirring before film formation. It also becomes possible to transfer materials having different reactivities onto both surfaces of the same film and control their characteristics, and to transfer materials that react with each other.

### EXAMPLES

### 4. Examples

In the present example, an anisotropic conductive film containing conductive particles was produced as one form of the adhesive film. A connection structure was then produced using the anisotropic conductive film, and conduction resistance, adhesive strength, and storage stability were evaluated.

### [Production of Anisotropic Conductive Film]

An anisotropic conductive film was produced using the materials shown below. The film size was set to 20 cm×30 cm.
Phenoxy resin: YP50, Nippon Steel Chemical & Material Co., Ltd.
Epoxy resin: YD-019, Nippon Steel Chemical & Material Co., Ltd.
Silica filler: AEROSIL 805, Nippon Aerosil Co., Ltd.
Alicyclic epoxy resin: CELOXIDE 8000, Daicel Corporation
Oxetane compound: OXBP, UBE Corporation
Silane coupling agent: KBM-403, Shin-Etsu Chemical Co., Ltd.
Thermal cationic curing agent: SI-60L, Sanshin Chemical Industry Co., Ltd.
Silanol compound: tris(tert-pentoxy) silanol (TPS)
Conductive particles (resin-core metal-coated conductive particles): AUL704, Sekisui Chemical Co., Ltd., 4 μmφ

### (Production of Aluminum Chelate Latent Curing Agent)

Eight hundred parts by mass of distilled water, 0.05 parts by mass of a surfactant (Newlex R-T, NOF Corporation), and 4 parts by mass of polyvinyl alcohol as a dispersant (PVA-205, Kuraray Co., Ltd.) were placed into a 3-liter interfacial polymerization vessel equipped with a thermometer and were uniformly mixed to prepare an aqueous phase.

To this aqueous phase, an oil phase was added in which 350 parts by mass of a 24% isopropanol solution of aluminum monoacetylacetonate bis(ethyl acetoacetate) (Alumichelate D, Kawaken Fine Chemicals Co., Ltd.), 49 parts by mass of an adduct of methylenediphenyl-4,4′-diisocyanate (3 mol) and trimethylolpropane (1 mol) (D-109, Mitsui Chemicals, Inc.) as a polyfunctional isocyanate compound, 21 parts by mass of divinylbenzene (Merck KGaA) as a radical-polymerizable compound, and 0.21 parts by mass of a radical polymerization initiator (Peroyl L, NOF Corporation) (an amount corresponding to 1 part by mass per 100 parts by mass of the radical-polymerizable compound) had been dissolved in 70 parts by mass of ethyl acetate. After emulsifying and mixing with a homogenizer (10,000 rpm/5 min; T-50, IKA Japan K.K.), interfacial polymerization and radical polymerization were performed at 80° C. for 6 hours. After completion of the reaction, the polymerization reaction mixture was cooled to room temperature, and polymerization particles were separated by filtration and dried naturally, thereby obtaining spherical aluminum chelate latent curing agent particles that had not been subjected to surface deactivation treatment.

This aluminum chelate latent curing agent was added to an impregnation solution composed of 40 parts by mass of a 24% isopropanol solution of aluminum monoacetylacetonate bis(ethyl acetoacetate) (Alumichelate D, Kawaken Fine Chemicals Co., Ltd.) and 60 parts by mass of ethanol, and after stirring at 30° C. for 6 hours, the particulate curing agent was separated by filtration and dried naturally, thereby obtaining a high-concentration type spherical aluminum chelate latent curing agent that had not been subjected to surface deactivation treatment.

Then, 3 parts by mass of n-propyltrimethoxysilane (KBM-303, Shin-Etsu Chemical Co., Ltd.) were dissolved in 27 parts by mass of cyclohexane to prepare a surface deactivation treatment solution, and 3 parts by mass of the aluminum chelate latent curing agent that had not been subjected to surface deactivation treatment were added to 30 parts by mass of this treatment solution. The mixture was stirred at 30° C. for 20 hours at 200 rpm to perform the surface deactivation treatment of the aluminum chelate latent curing agent. After completion of the treatment reaction, the polymer particles were separated from the treatment solution by filtration and dried naturally, thereby obtaining a high-concentration type spherical aluminum chelate latent curing agent that had been subjected to surface deactivation treatment.

In addition, regarding the average particle diameter of the aluminum chelate latent curing agent, measurement was performed using an automated flow-type particle image analysis apparatus (FPIA-3000, Malvern Instruments), and the result was 3 μm.

### (Production of Transfer Substrate)

A mold having a square-lattice arrangement of projections with predetermined number densities (12,000 pieces/mm², 24,000 pieces/mm², 36,000 pieces/mm²) was produced. By pouring transparent resin pellets into the mold in a molten state, and cooling and solidifying them, transfer substrates having square-lattice arrangements of recesses with predetermined number densities (12,000 pieces/mm², 24,000 pieces/mm², 36,000 pieces/mm²) were produced.

### [Production of Connection Structure]

An evaluation IC and a glass substrate as shown below were prepared.

### (Evaluation IC for Conduction Characteristics)

Outer dimensions: 1.8×20.0 mm
Thickness: 0.5 mm
Bump specification: size 30×85 μm, bump pitch 50 μm, bump height 9 μm

### (Glass Substrate)

Glass material: 1737F manufactured by Corning Incorporated
Outer dimensions: 30×50 mm
Thickness: 0.5 mm
Electrode: ITO wiring

The anisotropic conductive films of each Example and Comparative Example were cut to an area sufficient for connection, sandwiched between the evaluation IC for conduction characteristics and the glass substrate, and pressed under bonding conditions of a temperature of 130° C.—a pressure of 70 MPa—a time of 5 sec, or bonding conditions of a temperature of 160° C.—a pressure of 70 MPa—a time of 5 sec, to produce connection structures.

### [Evaluation of Conduction Resistance]

For the connection structures produced under the bonding conditions of a temperature of 130° C. or a temperature of 160° C., the resistance value (Ω) when a current of 1 mA was applied by the four-terminal method was measured using a digital multimeter (34401A, Agilent Technologies Inc.). The evaluation of the conduction resistance was performed for the connection structures (N=10) of each Example or Comparative Example according to the following criteria, and the lowest rating was taken as the rating of the Example or Comparative Example.
A: The maximum resistance value is less than 2Ω
B: The maximum resistance value is 2Ω or more and 4Ω or less
C: The maximum resistance value exceeds 4Ω

### [Evaluation of Die Shear Strength]

For the connection structures produced under the bonding conditions of a temperature of 130° C. or a temperature of 160° C., the die shear strength of the evaluation IC was measured under conditions of a tool speed of 0.2 mm/sec using a die shear tester (4000 series, Nordson Advanced Technology K.K.). The evaluation of the die shear strength was performed for the connection structures (N=10) of each Example or Comparative Example according to the following criteria, and the lowest rating was taken as the rating of the Example or Comparative Example.
AA: Die shear strength exceeds 900 N
A: Die shear strength is 600 N or more and 900 N or less
B: Die shear strength is 300 N or more and 600 N or less
C: Die shear strength is less than 300 N

### [Evaluation of Storage Stability]

The anisotropic conductive film was subjected to an aging treatment under environmental conditions of a temperature of 40° C. and a time of 8 hours. Using the anisotropic conductive film after the aging treatment, connection structures were produced under bonding conditions of a temperature of 130° C., a pressure of 70 MPa, and a time of 5 sec in the same manner as the above-described method for producing connection structures. Then, for the connection structures connected using the anisotropic conductive film after the aging treatment, the die shear strength was measured in the same manner as the above-described evaluation of die shear strength. The evaluation of the storage stability was performed for the connection structures (N=10) of each Example or Comparative Example according to the following criteria, relative to the die shear strength of the connection structures connected using the anisotropic conductive film not subjected to aging treatment, and the lowest rating was taken as the rating of the Example or Comparative Example.
AA: Decrease in die shear strength is less than 10%
A: Decrease in die shear strength is 10% or more and 30% or less
B: Decrease in die shear strength is 30% or more and 50% or less
C: Decrease in die shear strength exceeds 50%

### Example 1

In Example 1, a film layer of a curing-agent-free adhesive composition, which does not contain a curing agent, was formed, and using a transfer substrate on which a latent curing agent had been placed, the latent curing agent was transferred onto the film layer to produce a conductive-particle-containing layer A1. Similarly, a film layer of a curing-agent-free adhesive composition, which does not contain a curing agent, was formed, and using a transfer substrate on which a latent curing agent had been placed, the latent curing agent was transferred onto the film layer to produce a conductive-particle-non-containing layer N1. Then, the conductive-particle-non-containing layer N1 was laminated onto the transfer surface of the aluminum chelate latent curing agent of the conductive-particle-containing layer A1, thereby producing a two-layer anisotropic conductive film.

### (Conductive-Particle-Containing Layer A1)

The materials shown in Table 1 were mixed in the presence of the solvent propylene glycol monomethyl ether acetate (PMA) to obtain a binder composition. This binder composition was applied onto a PET film using a bar coater and dried in an oven at a temperature of 80° C. for 5 minutes to form a binder layer having a thickness of 4 μm on the PET film.

Conductive particles were filled into the recesses of the transfer substrate having a particle number density of 24,000 particles/mm², and one surface of the binder layer was placed over the substrate. By applying pressure (conditions: temperature 40-50° C., pressure 0.5 MPa), the conductive particles were adhered to the surface of the binder layer. Then, the binder layer was peeled from the transfer substrate, and the conductive particles on the binder layer were pressed (conditions: temperature 40-50° C., pressure 0.5 MPa) and embedded into the binder layer, thereby arranging the conductive particles on one surface of the binder layer.

Using a transfer substrate in which recesses were formed at a predetermined particle number density, the aluminum chelate latent curing agent was filled into the recesses such that the content of the aluminum chelate latent curing agent in the film layer would be 4 wt %, and the aluminum chelate latent curing agent outside the recesses was removed with a squeegee. One surface of the binder layer was placed over the transfer substrate in which the recesses had been filled with the aluminum chelate latent curing agent, and by applying pressure (conditions: temperature 40-50° C., pressure 0.5 MPa), the aluminum chelate latent curing agent was adhered to the surface of the binder layer. Then, the binder layer was peeled from the transfer substrate, and the aluminum chelate latent curing agent on the binder layer was pressed (conditions: temperature 40-50° C., pressure 0.5 MPa) and embedded into the binder layer, thereby arranging the aluminum chelate latent curing agent on the other surface of the binder layer and producing the conductive-particle-containing layer A1.

### (Non-Conductive-Particle-Containing Layer N1)

The materials shown in Table 1 were mixed in the presence of the solvent propylene glycol monomethyl ether acetate (PMA) to obtain a binder composition. This binder composition was coated onto a PET film using a bar coater, and dried in an oven at 80° C. for 5 minutes to form a binder layer having a thickness of 8 μm on the PET film.

Using a transfer substrate having recesses formed therein at a predetermined number density, an amount of the aluminum chelate latent curing agent was filled into the recesses such that the content of the aluminum chelate latent curing agent in the film layer would be 4 wt %, and the aluminum chelate latent curing agent present outside the recesses was removed with a squeegee. One surface of the binder layer was then placed over the transfer substrate in which the recesses had been filled with the aluminum chelate latent curing agent, and by applying pressure (conditions: temperature 40-50° C., pressure 0.5 MPa), the aluminum chelate latent curing agent was adhered onto the surface of the binder layer. Thereafter, the binder layer was peeled from the transfer substrate, and the aluminum chelate latent curing agent on the binder layer was pressed (conditions: temperature 40-50° C., pressure 0.5 MPa) and press-fit into the binder layer to place the aluminum chelate latent curing agent on one surface of the binder layer. In the same manner, the aluminum chelate latent curing agent was placed on the other surface of the binder layer, thereby producing the non-conductive-particle-containing layer N1.

Table 1 shows the evaluation results of the conduction resistance, die shear strength, and storage stability in Example 1. In Example 1, since the aluminum chelate latent curing agent is placed after film formation, the influence of the solvent can be suppressed, and excellent conduction resistance, die shear strength, and storage stability can be obtained. In addition, when the cross section of the two-layer anisotropic conductive film produced in Example 1 was observed with an electron microscope, the distance, in the film-thickness direction, between adjacent latent curing agents was at most about 5 μm in the non-conductive-particle-containing layer N1.

### Comparative Example 1

In Comparative Example 1, a film layer of a curing-agent-free adhesive composition not containing a curing agent was formed, and the latent curing agent was sprinkled onto the surface of the film layer to produce a conductive-particle-containing layer A2. Likewise, a film layer of a curing-agent-free adhesive composition not containing a curing agent was formed, and the latent curing agent was sprinkled onto the surface of the film layer to produce a non-conductive-particle-containing layer N2. Then, the non-conductive-particle-containing layer N2 was laminated onto the surface of the conductive-particle-containing layer A2 onto which the aluminum chelate latent curing agent had been sprinkled, thereby producing a two-layer type anisotropic conductive film.

### (Conductive-Particle-Containing Layer A2)

The materials shown in Table 1 were mixed in the presence of a solvent, propylene glycol monomethyl ether acetate (PMA), to obtain a binder composition. This binder composition was applied onto a PET film using a bar coater and dried for 5 minutes in an oven at 80° C., thereby forming a binder layer having a thickness of 4 μm on the PET film.

Conductive particles were filled into the recesses of a transfer substrate having a number density of 24,000 recesses/mm², and one surface of the binder layer was placed over the transfer substrate. By applying pressure (conditions: temperature 40-50° C., pressure 0.5 MPa), the conductive particles were adhered to the surface of the binder layer. Then, the binder layer was peeled from the transfer substrate, and the conductive particles on the binder layer were pressed (conditions: temperature 40-50° C., pressure 0.5 MPa) and pushed into the binder layer, thereby arranging the conductive particles on one surface of the binder layer.

In order for the content of the aluminum chelate latent curing agent to be 4 wt %, the aluminum chelate latent curing agent was sprinkled onto the other surface of the binder layer, and the aluminum chelate latent curing agent was adhered to the surface of the binder layer. Then, by pressing the aluminum chelate latent curing agent on the binder layer (conditions: temperature 40-50° C., pressure 0.5 MPa) and pushing it into the binder layer, the aluminum chelate latent curing agent was arranged on the other surface of the binder layer, thereby producing the conductive-particle-containing layer A2.

### (Conductive-Particle-Non-Containing Layer N2)

The materials shown in Table 1 were mixed in the presence of the solvent propylene glycol monomethyl ether acetate (PMA) to obtain a binder composition. This binder composition was applied onto a PET film using a bar coater and dried in an oven at 80° C. for 5 minutes to form, on the PET film, a binder layer having a thickness of 8 μm.

In order that the compounding amount of the aluminum chelate latent curing agent in the film layer would become 4 wt %, the aluminum chelate latent curing agent was sprinkled onto one surface of the binder layer, and the aluminum chelate latent curing agent was made to adhere to the surface of the binder layer. Then, by pressing (conditions: temperature 40-50° C., pressure 0.5 MPa) the aluminum chelate latent curing agent on the binder layer and thereby pushing it into the binder layer, the aluminum chelate latent curing agent was disposed on one surface of the binder layer. Likewise, the aluminum chelate latent curing agent was sprinkled onto the other surface of the binder layer, and the aluminum chelate latent curing agent was disposed on the other surface of the binder layer, thereby producing the conductive-particle-non-containing layer N2.

Table 1 shows the evaluation results of conduction resistance, die shear strength, and storage stability in Comparative Example 1. In Comparative Example 1, since the aluminum chelate latent curing agent was sprinkled to be disposed, the aluminum chelate latent curing agent partially aggregated, and there were portions where curing was insufficient, and excellent conduction resistance, die shear strength, and storage stability could not be obtained. It should be noted that, in Comparative Example 1, some connection structures exhibited sufficient performance, and the best conduction resistance was rated A at both the low temperature and the high temperature, the best die shear strength was rated AA at both the low temperature and the high temperature, and the best storage stability was also rated AA. This is presumed to be because the latent curing agent was sprinkled manually, causing the performance of the adhesive film to deteriorate in some locations and resulting in unstable performance of the adhesive film.

### Comparative Example 2

In Comparative Example 2, as shown in Table 1, an adhesive composition obtained by mixing the aluminum chelate latent curing agent and the silanol compound was prepared, and the preparation of the conductive-particle-containing layer A3 and the preparation of the conductive-particle-non-containing layer N3 were attempted. However, in Comparative Example 2, in the preparation of the conductive-particle-containing layer A3 and in the preparation of the conductive-particle-non-containing layer N3, the aluminum chelate latent curing agent reacted with the solvent during mixing and generated heat and cured, and therefore could not be formed into a film.

TABLE 1

| | | | | Comparative | | Comparative | |
|---|---|---|---|---|---|---|---|
| | | Example 1 | | Example 1 | | Example 2 | |
| Layer structure | | A1 | N1 | A2 | N2 | A3 | N3 |
| Phenoxy resin | YP-50 | 35 | 35 | 35 | 35 | 35 | 35 |
| Epoxy resin | YD-019 | — | 12 | — | 12 | — | 12 |
| Silica filler | Aerosil805 | 15 | 3 | 15 | 3 | 15 | 3 |
| Alicyclic epoxy | Celoxide | 30 | 30 | 30 | 30 | 30 | 30 |
| compound | 8000 | | | | | | |
| Oxetane | OXBP | 10 | 10 | 10 | 10 | 10 | 10 |
| compound | | | | | | | |
| Silane coupling | KBM-403 | 2 | 2 | 2 | 2 | 2 | 2 |
| agent | | | | | | | |
| Thermal cationic | SI-60L | — | — | — | — | — | — |
| curing agent | | | | | | | |
| Silanol compound | TPS | 8 | 8 | 8 | 8 | 8 | 8 |
| Binder total (parts by mass) | | 100 | 100 | 100 | 100 | 100 | 100 |
| Aluminum chelate | Addition | One-side | Both-side | One-side | Both-side | Mixing | Mixing |
| latent curing | method | transfer 4 | transfer 4 | sprinkling 4 | sprinkling 4 | 8 | 8 |
| agent | [wt %] | | | | | | |
| Conductive | Addition | One-side | — | One-side | — | — | — |
| particles | method | transfer | | transfer | | | |
| | [particles/ | 24000 | | 24000 | | | |
| | mm²] | | | | | | |

| | | | | | | |
|---|---|---|---|---|---|---|
| Film thickness [μm] | 4 | 8 | 4 | 8 | — | — |

| | | | |
|---|---|---|---|
| Conductive resistance | A | C | — |
| Low temp. (130 °C) | | | |
| Conductive resistance | A | B | — |
| High temp. (160 °C) | | | |
| Die-shear strength | A | C | — |
| Low temp. (130 °C) | | | |
| Die-shear strength | A | B | — |
| High temp. (160 °C) | | | |
| Storage stability(40 °C 8 h) | AA | B | — |
| press-bonding evaluation | | | |

### Example 2

In Example 2, except for using a transfer substrate having recesses formed at a prescribed number density such that the content of the aluminum chelate latent curing agent in the film layer became 8 wt %, a conductive-particle-containing layer A4 was produced in the same manner as the conductive-particle-containing layer A1. Likewise, except for using a transfer substrate having recesses formed at a prescribed number density such that the content of the aluminum chelate latent curing agent in the film layer became 8 wt %, a conductive-particle-non-containing layer N4 was produced in the same manner as the conductive-particle-non-containing layer N1. Then, the conductive-particle-non-containing layer N4 was laminated onto the transfer surface of the aluminum chelate latent curing agent of the conductive-particle-containing layer A4, thereby producing a two-layer anisotropic conductive film.

Table 2 shows the evaluation results of conduction resistance, die shear strength, and storage stability in Example 2. In Example 2, because the aluminum chelate latent curing agent was arranged after film formation, the influence of the solvent was suppressed, and excellent conduction resistance, die shear strength, and storage stability were obtained. In addition, the die shear strength at high temperature was superior compared with Example 1.

### Example 3

In Example 3, except for using a transfer substrate having recesses formed at a prescribed number density such that the content of the aluminum chelate latent curing agent in the film layer became 12 wt %, a conductive-particle-containing layer A5 was produced in the same manner as the conductive-particle-containing layer A1. Likewise, except for using a transfer substrate having recesses formed at a prescribed number density such that the content of the aluminum chelate latent curing agent in the film layer became 12 wt %, a conductive-particle-non-containing layer N5 was produced in the same manner as the conductive-particle-non-containing layer N1. Then, the conductive-particle-non-containing layer N5 was laminated onto the transfer surface of the aluminum chelate latent curing agent of the conductive-particle-containing layer A5, thereby producing a two-layer anisotropic conductive film.

Table 2 shows the evaluation results of the conduction resistance, die shear strength, and storage stability in Example 3. In Example 3, because the aluminum chelate latent curing agent was arranged after film formation, the influence of the solvent was suppressed, and excellent conduction resistance, die shear strength, and storage stability were obtained. In addition, the die shear strength at both high temperature and low temperature was superior compared with Example 1.

### Example 4

In Example 4, the materials shown in Table 2 were mixed in the presence of the solvent propylene glycol monomethyl ether acetate (PMA), and a prescribed amount of conductive particles was further mixed such that the number density became 24,000 particles/mm², thereby obtaining a binder composition. This binder composition was applied onto a PET film using a bar coater and dried in an oven at 80° C. for 5 minutes, thereby forming a binder layer having a thickness of 4 μm on the PET film. Then, except for using a transfer substrate having recesses formed at a prescribed number density such that the content of the aluminum chelate latent curing agent in the film layer became 8 wt %, a conductive-particle-containing layer A6 was produced in the same manner as the conductive-particle-containing layer A1.

In addition, except for using a transfer substrate having recesses formed at a prescribed number density such that the content of the aluminum chelate latent curing agent in the film layer became 8 wt %, a conductive-particle-non-containing layer N6 was produced in the same manner as the conductive-particle-non-containing layer N1. Then, the conductive-particle-non-containing layer N6 was laminated onto the transfer surface of the aluminum chelate latent curing agent of the conductive-particle-containing layer A6, thereby producing a two-layer anisotropic conductive film.

Table 2 shows the evaluation results of the conduction resistance, die shear strength, and storage stability in Example 4. In Example 4, because the aluminum chelate latent curing agent was arranged after film formation, the influence of the solvent was suppressed, and excellent conduction resistance, die shear strength, and storage stability were obtained. In addition, the die shear strength at high temperature was superior compared with Example 1.

### Comparative Example 3

In Comparative Example 3, instead of the silanol compound and the aluminum chelate latent curing agent, a thermal cationic polymerization initiator was used to produce a conductive-particle-containing layer A7 and a conductive-particle-non-containing layer N7. The materials shown in Table 2 were mixed in the presence of the solvent propylene glycol monomethyl ether acetate (PMA) to obtain a binder composition. This binder composition was applied onto a PET film using a bar coater and dried in an oven at 80° C. for 5 minutes to form a binder layer having a thickness of 4 μm on the PET film.

Conductive particles were filled into the recesses of a transfer substrate having a number density of 24,000 per mm², and one surface of the binder layer was placed over the transfer substrate. By pressing (conditions: temperature 40-50° C., pressure 0.5 MPa), the conductive particles were adhered to the surface of the binder layer. Then, the binder layer was peeled from the transfer substrate, and the conductive particles on the binder layer were pressed (conditions: temperature 40-50° C., pressure 0.5 MPa) and embedded into the binder layer, and the conductive particles were arranged on one surface of the binder layer, thereby producing the conductive-particle-containing layer A7.

In addition, the materials shown in Table 1 were mixed in the presence of the solvent propylene glycol monomethyl ether acetate (PMA) to obtain a binder composition. This binder composition was applied onto a PET film using a bar coater and dried in an oven at 80° C. for 5 minutes to form a binder layer having a thickness of 8 μm on the PET film, thereby producing a conductive-particle-non-containing layer N7. Then, the conductive-particle-containing layer A7 and the conductive-particle-non-containing layer N7 were laminated to produce a two-layer anisotropic conductive film.

Table 2 shows the evaluation results of the conduction resistance, die shear strength, and storage stability in Comparative Example 3. In Comparative Example 3, although an anisotropic conductive film could be produced because a thermal cationic curing agent having high solvent resistance was used, the die shear strength under low-temperature bonding was small, and the storage stability was also low. This is considered to be due to the influence of the solvent on the curing agent during film formation.

TABLE 2

| | | | | | | | | Comparative | |
|---|---|---|---|---|---|---|---|---|---|
| | | Example2 | | Example3 | | Example4 | | Example3 | |
| Layer structure | | A4 | N4 | A5 | N5 | A6 | N6 | A7 | N7 |
| Phenoxy resin | YP-50 | 35 | 35 | 35 | 35 | 35 | 35 | 35 | 35 |
| Epoxy resin | YD-019 | — | 12 | — | 12 | — | 12 | — | 12 |
| Silica filler | Aerosil805 | 15 | 3 | 15 | 3 | 15 | 3 | 15 | 3 |
| Alicyclic epoxy | Celoxide | 30 | 30 | 30 | 30 | 30 | 30 | 30 | 30 |
| compound | 8000 | | | | | | | | |
| Oxetane | OXBP | 10 | 10 | 10 | 10 | 10 | 10 | 10 | 10 |
| compound | | | | | | | | | |
| Silane coupling | KBM-403 | 2 | 2 | 2 | 2 | 2 | 2 | 2 | 2 |
| agent | | | | | | | | | |
| Thermal cationic | SI-60L | — | — | — | — | — | — | 8 | 8 |
| curing agent | | | | | | | | | |
| Silanol compound | TPS | 8 | 8 | 8 | 8 | 8 | 8 | — | — |
| Binder total (parts by mass) | | 100 | 100 | 100 | 100 | 100 | 100 | 100 | 100 |
| Aluminum chelate | Addition | One-side | Both-side | One-side | Both-side | One-side | Both-side | — | — |
| latent curing | method | transfer 8 | transfer 8 | transfer 12 | transfer 12 | transfer 8 | transfer 8 | | |
| agent | [wt %] | | | | | | | | |
| Conductive | Addition | One-side | — | One-side | — | Mixing | — | One-side | — |
| particles | method | transfer | | transfer | | 24000 | | transfer | |
| | [particles/ | 24000 | | 24000 | | | | 24000 | |
| | mm²] | | | | | | | | |

| | | | | | | | | |
|---|---|---|---|---|---|---|---|---|
| Film thickness | 4 | 8 | 4 | 8 | 4 | 8 | 4 | 8 |
| [μm] | | | | | | | | |

| | | | | |
|---|---|---|---|---|
| Conductive resistance | A | A | A | A |
| Low temp. (130 °C) | | | | |
| Conductive resistance | A | A | A | A |
| High temp. (160 °C) | | | | |
| Die-shear strength | A | AA | A | B |
| Low temp. (130 °C) | | | | |
| Die-shear strength | AA | AA | AA | AA |
| High temp. (160 °C) | | | | |
| Storage | A | A | A | C |
| stability(40 °C 8 h) | | | | |
| press-bonding evaluation | | | | |

### EXPLANATION OF REFERENCE SIGNS

11: base film; 12: film layer; 12A: first surface; 13: latent curing agent; 20: transfer substrate; 32: film layer; 32A: first surface; 32B: second surface; 33: latent curing agent; 34: latent curing agent; 42: film layer; 42A: first surface; 42B: second surface; 43A: latent curing agent; 43B: latent curing agent; 52: film layer; 52A: first surface; 52B: second surface; 53: latent curing agent; 53: conductive particle.

1. A method for manufacturing an adhesive film, the method including:
a forming step of forming a film layer of a curing-agent-free adhesive composition that contains no curing agent; and
a placing step of transferring a latent curing agent from a transfer substrate on which the latent curing agent is disposed to the film layer, and disposing the latent curing agent so as to be exposed from at least one surface of the film layer or disposed in proximity to at least one surface of the film layer.

2. The method for manufacturing an adhesive film according to claim 1, wherein the latent curing agent is disposed in a lump form in the film layer.

3. The method for manufacturing an adhesive film according to claim 1, wherein the latent curing agent is of a microcapsule type.

4. The method for manufacturing an adhesive film according to claim 1, wherein the curing-agent-free adhesive composition comprises a film-forming resin, a cationically polymerizable compound, and a silane compound, and
wherein the latent curing agent is an aluminum chelate latent curing agent.

5. The method for manufacturing an adhesive film according to claim 1, further comprising a conductive-particle placing step of disposing conductive particles in the film layer.

6. The method for manufacturing an adhesive film according to claim 1, wherein, in the forming step, conductive particles are blended into the curing-agent-free adhesive composition, and a film layer containing the conductive particles is formed.

7. An adhesive film comprising:
a film layer of an adhesive composition in which a latent curing agent is exposed from at least one surface or is disposed in proximity to at least one surface;
wherein the latent curing agent has an average particle diameter of 2 μm to 50 μm, and
the film layer has a thickness of 3 μm to 40 μm.

8. A conductive film comprising:
a film layer containing conductive particles, in which a latent curing agent is exposed from at least one surface or is disposed in proximity to at least one surface;
wherein the latent curing agent has an average particle diameter of 2 μm to 50 μm, and
the film layer has a thickness of 3 μm to 40 μm.

9. An anisotropic conductive film comprising:
a film layer containing conductive particles, in which a latent curing agent is exposed from at least one surface or is disposed in proximity to at least one surface;
wherein the latent curing agent has an average particle diameter of 2 μm to 50 μm, and the film layer has a thickness of 3 μm to 40 μm.

10. A method for manufacturing a structure, the method comprising bonding a first component and a second component via the adhesive film according to claim 7.

11. A method for manufacturing a connection structure, the method comprising connecting a terminal of a first component and a terminal of a second component via the adhesive film according to claim 7.

12. A structure in which a first component and a second component are bonded via the adhesive film according to claim 7.

13. A connection structure in which a terminal of a first electronic component and a terminal of a second electronic component are connected via the adhesive film according to claim 7.

14. The method for manufacturing an adhesive film according to claim 2,
wherein the latent curing agent is of a microcapsule type.

15. The method for manufacturing an adhesive film according to claim 2, wherein the curing-agent-free adhesive composition comprises a film-forming resin, a cationically polymerizable compound, and a silane compound, and
wherein the latent curing agent is an aluminum chelate latent curing agent.

16. The method for manufacturing an adhesive film according to claim 2, further comprising a conductive-particle placing step of disposing conductive particles in the film layer.

17. The method for manufacturing an adhesive film according to claim 2, wherein, in the forming step, conductive particles are blended into the curing-agent-free adhesive composition, and a film layer containing the conductive particles is formed.
